(19) United States
(12) Patent Application Publication
(10) Pub. No.: US 2018/0125058 A1
(43) Pub. Date: May 10, 2018

(54) Multifunctional animal repeller

(71) Applicant: Yu-Chen Liu, Shenzhen (CN)

(72) Inventor: Yu-Chen Liu, Shenzhen (CN)

(21) Appl. No.: 15/866,475

(22) Filed: Jan. 10, 2018

(30) Foreign Application Priority Data
Dec. 25, 2017 (CN) 201711421611.3

(51) Int. Cl. A01M 29/10; A01M 29/18; A01M 29/08

(52) U.S. Cl. CPC A01M 29/10; A01K 11/006; A01M 29/08; A01M 29/18

(57) ABSTRACT

The invention relates to a multifunctional animal repeller including a central processing unit, and a sound output circuit, a light output circuit, an ultrasonic output circuit, a red light blinking output circuit, a various animal deterrence sound programmer, an ultrasonic frequency selection controller, a multifunctional light selector, an animal repelling mode controller, an operating time selection button, an infrared induction distance adjuster, a photosensitive detector, a camera, a pre-amplification circuit, a mass memory, a Wifi module, a camera effect monitor and a multi-power supply system which are all connected with the central processing unit. The multifunction animal repeller can repel different animals through physical phenomena such as sounds, ultrasonic waves and flashing light based on a humane animal repelling design and can protect animals against injuries, and thus the natural environment is protected.

### BACKGROUND OF THE INVENTION

### Technical Field

The invention relates to a multifunctional animal repeller, in particular to an animal repeller integrating sounds, light and ultrasonic waves.

### Description of Related Art

Sounds of animal natural enemies can be used for repelling animals, specifically, certain noxious animals have natural enemies; for example, mice are afraid of cats, chickens are afraid of eagles, fawns are afraid of lions, and rabbits are afraid of wolves; by means of the characteristics of animals, noxious animals can be effectively repelled through natural enemy sounds simulated artificially.

Flashing lamps can be used for repelling animals, specifically, certain small timid animals such as mice, rabbits, wild boars, squirrels and wolves are extremely sensitive to flashing light at night and thus flee when seeing flashing light.

Red light can be used for repelling animals, specifically, one or more red-light lamps flash to imitate blinking of animal natural enemies to deter animals such as goats, rabbits, squirrels, mice, wild dogs and wild boars.

Ultrasonic waves can be used for repelling animals, specifically, mainly by means of the characteristic of wide acoustic frequency bands of certain animals, ultrahigh-frequency ultrasonic waves are used for repelling mice, dogs, wolves, cats and certain insects, and high-power ultrasonic waves repeatedly stimulate auditory nerves of animals, so that the animals are made fretful and uneasy and then flee the uncomfortable generation environment due to endocrine dyscrasia.

Similar products on the present market have only one function, are poor in intelligence and cannot be used flexibly, and consequentially can only repel a few species of animals, are poor in effect and cannot achieve the good animal repelling effect achieved through integration of various functions.

### BRIEF SUMMARY OF THE INVENTION

According to the technical scheme adopted by the invention for solving the technical problems: a multifunctional animal repeller is provided and can repel different animals through physical phenomena such as sounds, ultrasonic waves and flashing light based on the humane animal repelling design and can protect animals against injuries, and thus the natural environment is protected.

To overcome the defects that existing products have only one function and are poor in animal repelling effect, the multifunctional animal repeller of the invention can repel animals through ultrasonic waves and flashing light, can repel animals through red flashing light at night and can also repel animals through ultrasonic waves independently. A red flashing lamp flashes to imitate blinking of animal natural enemies and automatically flashes at night to deter and repel animals. When animals approach in any time period and are detected by infrared rays, powerful ultrasonic waves are also started to repel the animals.

The multifunctional animal repeller of the invention can repel animals through ultrasonic waves and ultra-bright quick-flashing lamps, and neither light or ultrasonic waves are started when no animal is detected. When it is detected through infrared rays that animals approach, ultrasonic waves are started to repel the animals, and strong quick-flashing light is also started to repel the animals at night, so that the animals do not dare to approach within a certain range and flee away.

The multifunctional animal repeller of the invention can repel animals through ultrasonic waves and sound waves, specifically, when it is detected through infrared rays that animals approach the body, powerful ultrasonic waves are started to repel the animals, and various ultra-strong animal natural enemy sounds are selected and started at the same time to repel the animals.

The multifunctional animal repeller of the invention comprises a sound loudspeaker and an ultrasonic wave loudspeaker so that sound waves and ultrasonic waves can be combined for repelling animals.

The multifunctional animal repeller of the invention can repel animals in various modes and can also repel animals through ultrasonic waves, sound waves and flashing light; ultrasonic waves, sound waves, animal natural enemy sounds and strong light are integrated to repel animals.

The multifunctional animal repeller of the invention patent comprises an operating time selection button and can repel animals in different time periods, specifically, the multifunctional animal repeller can repel animals only in daytime, or repel animals only at night, or repel animals in 24 hours and in all weather; the repelling selection functional button can be freely selected according to the activity rule of local noxious animals. The functional button is used in cooperation with an animal repelling mode controller and cannot be used independently.

The multifunctional animal repeller of the invention comprises the animal repelling mode controller and has an infrared trigger mode, a continuous intermittent output mode and a sweep-frequency output mode. (1) For the infrared trigger mode, ultrasonic waves and sounds are output to repel animals only when infrared trigger occurs, and if the light option is selected, flashing lamps are also used at night to deter animals; (2) for the continuous intermittent output mode, infrared trigger is not needed, and ultrasonic waves and sounds are output continuously and intermittently to repel animals, and if the light option is selected, flashing lamps are also used at night to deter animals; and the continuous intermittent output mode is suitable for the occasion where a large number of animals not sensitive to infrared induction approach; (3) for the sweep-frequency output mode, ultrasonic waves and sounds are output at a sweep frequency to repel animals, and the frequency of ultrasonic waves is changed automatically through sweeping, so that animals of different species are repelled; if the light option is selected, flashing lamps are also used at night to deter animals. The operating time of the animal repelling mode controller depends on the operating time selected through the operating time selection button.

The multifunctional animal repeller of the invention comprises an ultrasonic frequency selection controller, the controller contains various ultrasonic frequencies according to the sensitivity of different animals to ultrasonic waves at different frequencies, and different repelling ultrasonic frequencies can be selected according to different animals to be repelled.

The multifunctional animal repeller of the invention comprises a various animal deterrence sound programmer which contains various animal natural enemy sounds, users can program and freely select required animal natural enemy sounds, no sound or various sounds can be combined freely, and selected sounds are cyclically played automatically to repel intrusion of animals when an induction device such as an infrared induction device is triggered by the intrusion of animals; ultrasonic waves are output synchronously to deter and repel the intrusion of animals together with the sounds, and flashing light is also used for deterring the animals at night, so that the effect is better.

The multifunctional animal repeller of the invention comprises a multifunctional light selector, and users can select light functions according to actual requirements. Firstly, the multifunctional animal repeller can provide light specially used for deterring intrusion of animals, light flashes quickly to deter animals at night, various deterring modes including light deterring, sound deterring and ultrasonic wave deterring are adopted at the same time, and thus the effect is much better than the effect of a single deterring mode; secondly, the multifunctional animal repeller has the function of an infrared induction emergency illuminating lamp, the illuminating lamp is turned on automatically when it is detected through infrared rays that people pass at night and is turned off a certain period of time later; thirdly, the multifunctional animal repeller has the function of an illuminating lamp, and if the function is selected, the illuminating lamp is manually controlled to be turned on or off; fourthly, the multifunctional animal repeller has an SOS function, and in the SOS mode, light flashes according to the international rescue standard so as to remind rescue workers; fifthly, the light selector can be turned off, and all the functions of the light selector can be disabled in the mode. The light selector is designed particularly for users to use the multifunctional animal repeller in different ranges, and the users can select the light state according to actual requirements.

Compared with the prior art, the multifunctional animal repeller of the invention has abundant functions obviously and can be used freely and conveniently. No sound or various animal natural enemy sounds can be freely combined and programmed; various light modes are provided, specifically, at night, flashing light can be selected to repel animals according to actual requirements, and sounds are stopped; or only sounds are selected to repel animals, and light is stopped; or both sounds for repelling animals and light for repelling animals can be stopped, and only ultrasonic waves are used for repelling animals; the required mode can be selected freely and flexibly according to actual requirements.

In the light mode, the multifunctional animal repeller of the invention can be used for repelling animals and can also be used for informing users of visitors, and sending outdoor SOS signals or night illuminating, so that unexpected requirements under various conditions during outdoor camping are met.

The multifunctional animal repeller of the invention has an TOT function, information such as the infrared induction frequency and time for animals can be uploaded to a cloud server for data storage, operation, analysis and summarization with Wifi, Bluetooth, CKB and the like as carriers, and thus the information can be inquired at any time or be transmitted to a mobile phone in real time directly through an APP so as to be supplied to the owner.

Images or data about activity tracks of animals are monitored in real time through photographing and uploaded to the cloud server for data storage, operation, analysis and summarization with Wifi, Bluetooth, CKB and the like as carriers so that the data can be inquired at any time or be transmitted to a mobile phone in real time directly through an APP so as to be supplied to the owner, and the owner can observe the scene in real time through the mobile phone and check data such as the activity condition of animals and video images after infrared trigger occurs.

The multifunctional animal repeller of the invention can repel animals through red-light lamps, specifically, one or more ultra-bright lamps emit red light to imitate blinking of animal natural enemies so as to deter and repel animals.

The multifunctional animal repeller of the invention can intelligently identify the species of animals, specifically, after infrared trigger occurs, a video camera is started to capture animal images, and the captured animal images are compared with a great number of stored animal images, so that the species of animals are determined; then one or the combination of ultrasonic waves, sound waves and light which can repel the animals most effectively are started correspondingly according to the species of the animals. One or more of barking sounds, alarm bell sounds, harsh ultrasonic sounds and flashing lamps can be started when images of people are captured by the video camera, so that an anti-theft effect is achieved; or all functional motions are stopped, so that the owner or a visitor is prevented from being disturbed.

### BRIEF DESCRIPTION OF THE SEVERAL VIEWS OF THE DRAWINGS

A further description of the invention is given with the accompanying drawing and an embodiment as follows, in the drawing:

FIG. 1 is a principle block diagram of a multifunctional animal repeller of the invention.

### DETAILED DESCRIPTION OF THE INVENTION

For a better understanding of the purposes, technical schemes and advantages of the invention, a further detailed description of the invention is given with the accompanying drawing and the embodiment. It should be understood that the specific embodiment in the following description is only used for explaining the invention instead of being used for limiting the invention.

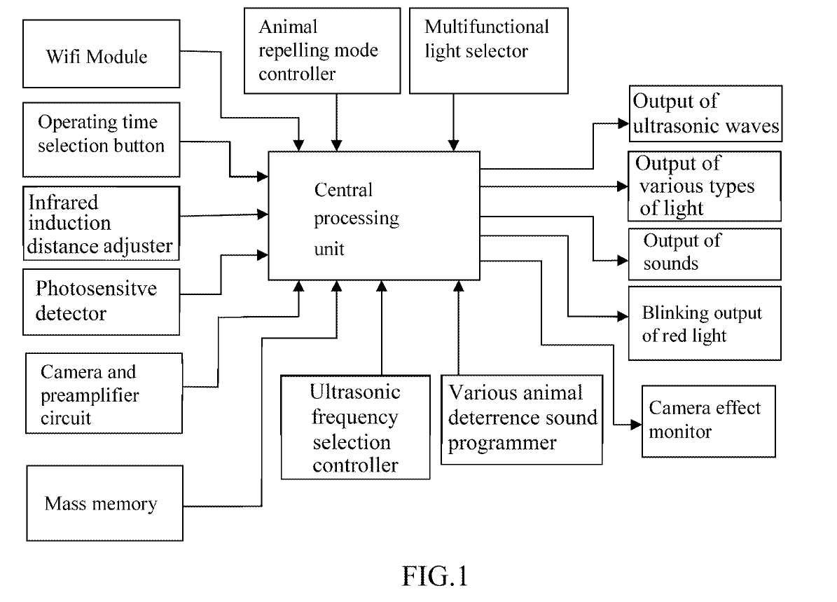

As is shown in FIG. 1 which is a principle block diagram of a multifunctional animal repeller of the invention, the multifunctional animal repeller comprises a central processing unit, a sound output circuit, a light output circuit, an ultrasonic output circuit, a red light blinking output circuit, a various animal deterrence sound programmer, an ultrasonic frequency selection controller, a multifunctional light selector, an animal repelling mode controller, an operating time selection button, an infrared induction distance adjuster, a photosensitive detector, a camera, pre-amplification circuit, a mass memory, a Wifi module, a camera effect monitor, a multi-power supply system and the like.

Specifically, a flashing lamp automatically flashes to repel animals at night, and if certain animals still approach, powerful ultrasonic waves or flashing light or natural enemy sounds are started instantly when the animals are detected through infrared rays or images about activities of the animals are monitored automatically.

Specifically, when it is detected through infrared rays that animals approach, ultrasonic waves are started to repel the animals, and at the moment, strong light flashes quickly to repel the animals; under the combined effect of the ultrasonic waves and the strong light, the animals can flee the scene and do not dare to approach within a certain distance, and thus the effect of repelling the animals is achieved.

Specifically, ultrasonic waves and animal natural enemy sounds can be used for repelling animals, and animals are detected through infrared rays when approaching, then ultrasonic waves are started to repel the animals forcibly. Various animal natural enemy sounds can be selected freely, corresponding animal natural enemy sounds are started to repel the animals forcibly when ultrasonic waves are started to repel the animals through infrared rays, and the animals (beasts) are effectively repelled by the ultrasonic waves and the sound waves and then flee the scene rapidly.

Specifically, animals can be repelled in various modes, and in actual use, the most effective repelling frequency of ultrasonic waves is selected through the ultrasonic frequency selection controller according to the species of animals; the proper ultrasonic frequency is selected through the ultrasonic frequency selection controller. Animal natural enemy sounds are selected from and programmed in the various animal deterrence sound programmer, and various natural enemy sounds are selected to repel animals according to the species of the animals actually to be repelled. For the light selection function, a quick-flashing light animal repelling mode can be selected if animals are to be repelled. One or more red-light LEDs are selected to imitate blinking of animal natural enemies, so that the animals are repelled.

Specifically, for example, during camping, when an animal approaches, an infrared induction controller is triggered to send a trigger signal to the central processing unit, and high-decibel ultrasonic waves are output to repel the animal under the control of the central processing unit; natural enemy roaring sounds are played at the same time to deter the animal, and light flashes quickly to deter the animal at night; through the three repelling modes, the animal flees and is prevented from harassing people, and the repelling effect is much better than the repelling effect of one repelling method. Animal natural enemy sounds are programmed and selected freely, then high-decibel ultrasonic waves are used for repelling the animal, and thus using is flexible and convenient.

Furthermore, for using the multifunctional animal repeller conveniently, an operating time selection button is used for selecting operating times, and the multifunctional animal repeller can operate in a daytime operating mode, a night operating mode and a 24-hour operating mode, and the operating time can be selected according to the actual condition. For example, if the multifunctional animal repeller is selected to repel animals in daytime, animals approaching at night will not be repelled, and the multifunctional animal repeller can operate in other operating modes by analogy.

Specifically, ultrasonic waves and sound waves can be output through infrared trigger to repel animals, or ultrasonic waves and sound waves can be output continuously and intermittent to repel animals. When animals of various species approach, ultrasonic waves and sound waves can be output at a sweep frequency, and the frequency of ultrasonic waves changes continuously; as different animals have different sensitivities to different ultrasonic frequencies, ultrasonic waves with the continuously-changing sweep frequency are used for repelling animals.

Specifically, various types of light can be quite useful during outdoor camping, and various light selection modes such as quick-flashing light for repelling animals, long-time illuminating light, infrared induction delayed illuminating light and SOS rescue light used when people get lost outdoors are provided.

Specifically, the multifunctional animal repeller of the invention is provided with a camera and has the Wifi function, the camera is started and connected with the IOT through Wifi when infrared trigger occurs, then activity tracks of animals can be observed in any place where access to the Internet is available, and thus the repelling mode can be adjusted in time; the camera can also be directly connected with a mobile phone, so that the activity condition of animals is monitored in real time through the mobile phone.

Specifically, a great number of animal images are pre-stored in a mass memory, after infrared trigger, the camera is started to capture animal images, and the captured animal images are compared with the original images in the memory, so that the species of animals are determined; then repelling combinations of ultrasonic waves, animal natural enemy sound waves, light and the like which can repel the animals most effectively are started intelligently according to the species of the animals. If a person enters the monitoring area, alarm sounds are given out at the moment to remind users to start video monitoring and to observe the activity of the person. Barking sounds or other sounds can also be given out to remind the users; or the function can be disabled.

Application/range of the invention:

The multifunctional animal repeller of the invention can be used for repelling noxious animals such as mice, wolves, wild dogs, pheasants, yellow weasel and wild boars and can also repel insects to a certain extent.

The multifunctional animal repeller of the invention can be used for outdoor camping, guarding of outdoor farms and gardens, and the like.

The effective range of the multifunctional animal repeller of the invention is about 400 square meters.

Although the invention is disclosed through the above embodiments, the protection scope of the invention is not limited to the above embodiments, and transformations, substitutes and the like of the above components made without deviating from the concept of the invention are all within the claim scope of the invention.

What is claimed is:

1. A multifunctional animal repeller, characterized by comprising a central processing unit, and a sound output circuit, a light output circuit, an ultrasonic output circuit, a red light blinking output circuit, a various animal deterrence sound programmer, an ultrasonic frequency selection controller, a multifunctional light selector, an animal repelling mode controller, an operating time selection button, an infrared induction distance adjuster, a photosensitive detector, a camera, a pre-amplification circuit, a mass memory, a Wifi module, a camera effect monitor and a multi-power supply system which are all connected with the central processing unit.

2. The multifunctional animal repeller according to claim 1, characterized in that at night, a flashing lamp automatically flashes to repel animals, and if certain animals still approach, powerful ultrasonic waves or flashing light or natural enemy sounds are started instantly when the animals are detected through infrared rays or images about activities of the animals are monitored automatically.

3. The multifunctional animal repeller according to claim 2, characterized in that the multifunctional animal repeller comprises the operating time selection button and thus can repel animals in different time periods, specifically, the multifunctional animal repeller can repel animals only in daytime, or repel animals only at night, or repel animals in 24 hours and in all weather; the repelling selection functional button can be freely selected according to the activity rule of local noxious animals. The functional button is used in cooperation with the animal repelling mode controller and cannot be used independently.

4. The multifunctional animal repeller according to claim 3, characterized in that when it is detected through infrared rays that animals approach, ultrasonic waves are started to repel the animals, and at the moment, strong light flashes quickly to repel the animals; under the combined effect of the ultrasonic waves and the strong light, the animals can flee the scene and do not dare to approach within a certain distance, and thus the effect of repelling the animals is achieved.

5. The multifunctional animal repeller according to claim 4, characterized in that ultrasonic waves and animal natural enemy sounds can be used for repelling animals, specifically, animals are detected through infrared rays when approaching, then ultrasonic waves are started to repel the animals forcibly, various animal natural enemy sounds can be selected freely, corresponding animal natural enemy sounds are started to repel the animals forcibly when ultrasonic waves are started to repel the animals through infrared rays, and the animals (beasts) are effectively repelled by the ultrasonic waves and the sound waves and then flee the scene rapidly.

6. The multifunctional animal repeller according to claim 5, characterized in that in actual use, the most effective repelling frequency of ultrasonic waves is selected through the ultrasonic frequency selection controller according to the species of animals.

7. The multifunctional animal repeller according to claim 6, characterized in that the proper ultrasonic frequency is selected through the ultrasonic frequency selection controller.

8. The multifunctional animal repeller according to claim 7, characterized in that animal natural enemy sounds are selected from and programmed in the various animal deterrence sound programmer, and various natural enemy sounds are selected to repel animals according to the species of animals actually to be repelled.

9. The multifunctional animal repeller according to claim 8, characterized in that light function is selected, and a light quick-flashing animal repelling mode can be selected if animals are to be repelled.

10. The multifunctional animal repeller according to claim 9, characterized in that one or more red-light LEDs are selected to imitate blinking of natural enemies of animals, so that the animals are repelled.

11. The multifunctional animal repeller according to claim 10, characterized in that during camping, when an animal approaches, an infrared induction controller is triggered to send a trigger signal to the central processing unit, and high-decibel ultrasonic waves are output to repel the animal under the control of the central processing unit; natural enemy roaring sounds are played at the same time to deter the animal, and light flashes quickly to deter the animal at night; through the three repelling modes, the animal flees and is prevented from harassing people, and the repelling effect is much better than the repelling effect of one repelling method.

12. The multifunctional animal repeller according to claim 11, characterized in that during outdoor camping, various types of light can be quite useful, and various light selection modes such as quick-flashing light for repelling animals, long-time illuminating light, infrared induction delayed illuminating light and SOS rescue light used when people get lost outdoors are provided.

13. The multifunctional animal repeller according to claim 12, characterized in that the multifunctional animal repeller is provided with a camera and has the Wifi function, the camera is started and connected with the IOT through Wifi when infrared trigger occurs, then activity tracks of animals can be observed in any place where access to the Internet is available, and thus the repelling mode can be adjusted in time; the camera can also be directly connected with a mobile phone, so that the activity condition of animals is monitored in real time through the mobile phone.
